(19) United States
(12) Patent Application Publication
(10) Pub. No.: US 2011/0056163 A1
(43) Pub. Date: Mar. 10, 2011

(54) FIRE PROTECTION OF A STRUCTURAL ELEMENT

(75) Inventor: Peter Kure, Klampenborg (DK)

(73) Assignee: ROCKWOOL INTERNATIONAL A/S

(21) Appl. No.: 12/920,214

(22) PCT Filed: Mar. 3, 2009
(86) PCT No.: PCT/DK09/50050

§ 371 Date: Nov. 23, 2010

(30) Foreign Application Priority Data
Mar. 4, 2008 (DK) PA 2008 00319

(51) Int. Cl. E04B 1/94; E04B 1/38; B32B 19/00; B32B 15/14

(52) U.S. Cl. 52/741.3; 52/745.21; 428/702; 428/537.7; 428/703; 428/472

(57) ABSTRACT

A system for fire protection of a structural element, which system comprising one or more fire protection boards attached to the said structural element, and one or more hard plates attached to an outer surface of the fire protection boards by means of a non-combustable adhesive, said hard plates having a harder surface than the fire protection board. A method for protecting a structural element is also disclosed.

The invention relates to a system for fire protection of a structural element in accordance with the introduction to claim 1. The invention also relates a method of providing such a fire protection system.

In building areas with access for people it is often a requirement that walls and other structural elements have a hard and point impact resistant surface. This is often achived by using heavy walls made of e.g. concrete or by using light walls made of e.g. steel profiles provided with gypsum plates. Some buildings are based on a load bearing steel structure comprising beams and columns made of steel. For safety reasons the steel beams and columns must be protected against fire so that the structure can withstand a fire for e.g. 60, 90 or 120 minutes before the structure collapses. This fire protection can be achieved by enveloping the beams and columns with fire protection boards, e.g. mineral wool boards known under the name Conlit® which are produced by the applicant of this patent application. However, in areas with access for persons there is often a requirement for a hard and point impact resistant surface, which is not achievable with the mineral wool boads alone. Conventionally, fire protection of steel structures in this area is obtained by using hard fire protection boards based on vermiculite or cement. However, these products form a lot of dust when they are cut to the correct sizes, and they must therefore be cut outside the building and with protecting garment for the persons who work with them. Alternatively, it is known to provide fire protection of steel structures be means of three layers of gypsum plates, which, however, requires a lot of cutting and adjusting to size. Thus, these conventional ways of providing a fire protection with a hard and point impact resistant surface are relatively expensive, so there is a need for a new solution in this field.

It is therefore an object of the present invention to provide a new and less work requiring solution for obtaining a hard surface in relation to fire protection of a structural element.

This object is achieved by arranging the system for fire protection of a structural element as mentioned in claim 1 and by the method described in claim 10.

By arranging the system as stated in claim 1 is first of all achieved a solution that is cheaper than the known solutions, since cheaper materials can be used in the system and still provide a fire-protection system which satisfy regulatory fire protection standards for buildings, such as ENV 13381 part 4.

By using fire protection boards made of mineral wool, preferably stone wool bonded by a binder, the dusting problem associated with vermiculite or cement based boards is eliminated which means that the boards can be cut and adjusted right at the site of the structural element. In stead of stone wool the mineral wool fire protection boards might be made of glass wool or a hybrid of stone and glass wool.

Preferably the mineral wool boards have a density of between 50 or 60 and 250 kg/m³, preferably between 90 and 200 kg/m³, and more preferably between 110 and 160 kg/m³. Mineral wool boards with these densities show excellent fire resistant properties and are sufficiently rigid to be easily handled and attached to the structure that need fire protection. In a presently particularly preferred embodiment boards of approx. 150 kg/m³ are being used.

The hard plates are preferably gypsum plates, preferably provided with a paper fleece on one or both sides. Such gypsum plates show excellent properties in relation to impact resistance, especially when they are supported on the rear side as it is the case in the invention where they are glued to the fire protection boards. The use of gypsum boards is particularly advantageous since the gypsum liberates water when being exposed to a fire.

The glue used in the system should be non-combustable and is preferably an adhesive that is based on cement. An adhesive of this type is made of inorganic material which is advantageous with resistance to fire and will therefore ensure a firm adhesion between the fire-protection boards of mineral wool and the hard plates, such as the gypsum plates so that this fire protection laminate structure is maintained during a fire and thereby prolongs its fire protective properties.

The invention can be used at various structural elements, but preferably the structural element is a part of a steel structure for a building, such as a steel beam or steel column. Alternatively, the structural element is a ventilation duct, a wall structure or the like. The structural elements may be beams or columns made of I- or H-shaped profiles.

The invention will be described in the following with reference to the drawings in which

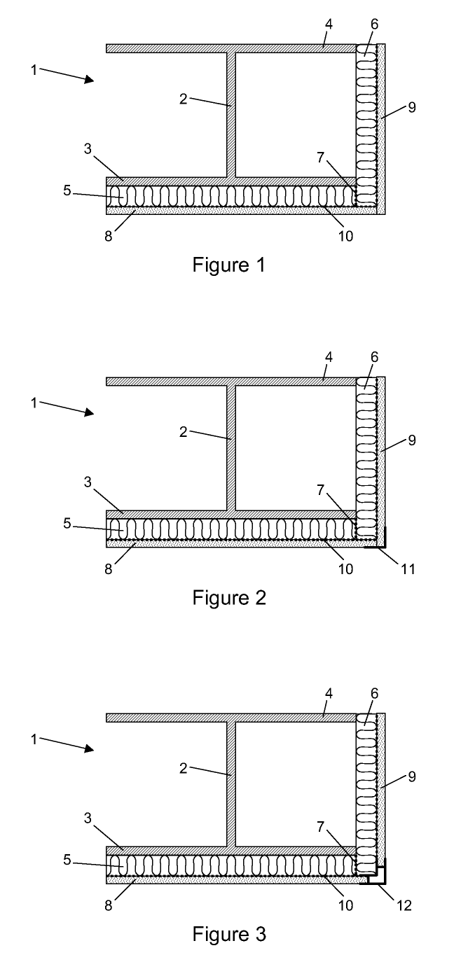

FIG. 1 shows a steel profile with a fire protection according to a first, basic embodiment of the invention,

FIG. 2 shows a steel profile with a fire protection according to a second embodiment of the invention,

FIG. 3 shows a steel profile with a fire protection according to a third embodiment of the invention, and

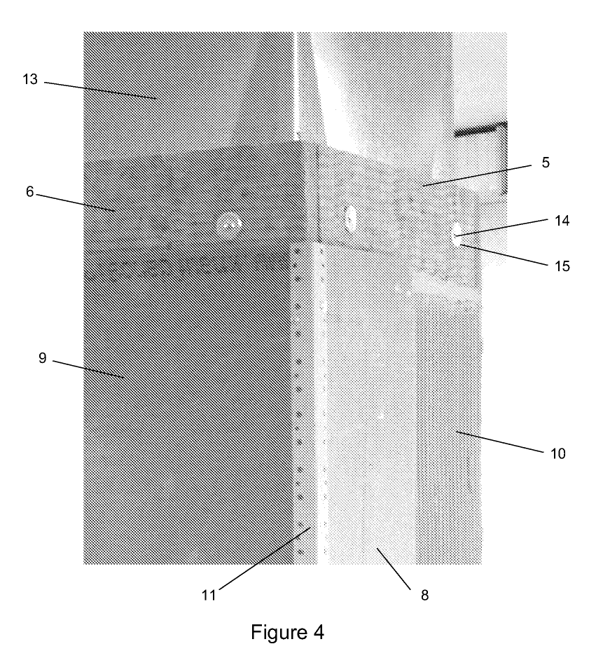

FIG. 4 shows photograph of the invention used on a ventilation duct.

FIG. 1 shows a steel profile 1 also known as a so-called H or I profile. Many buildings today comprise a bearing structure made of such steel profiles 1, where they often are arranged as horizontal beams or vertical columns. The steel profiles may of course also be inclined and the cross-section can differ from the H- or I-shape shown in FIG. 1. Since the steel profiles constitute the bearing structure of the building it is important to protect them against fire, so that the building does not collapse to fast due to softening of the profiles caused by the heat of a fire. Generally, the fire protection should be able to prevent the building form collapsing before 60, 90 or 120 minutes, so that there is sufficient time for people to leave the building before it collapses.

The steel profile 1 comprises a centre beam 2 and two flanges 3 and 4. In order to fire protect the profile 1 fire protection boards 5 and 6 are attached to the flanges 3 and 4 by any known means. The fire protection boards 5 and 6 are preferably boards made of bonded mineral wool, e.g. stone wool boards known under the name Conlit® and produced by Rockwool® in thicknesses from 15 to 50 mm and with a density of approx. 120-150 kg/m³. In the shown example the fire protection boards 5 and 6 are arranged around a corner of the steel profile 1, and the interface between the fire protection boards at the corner is provided with glue 7. It should be understood that often the steel profile 1 is a free standing column and it will then be provided with fire protection boards 5 and 6 on all four sides (not shown) with all interfaces between the fire protection boards being glued together. This is a well-known way of attaching Conlit® fire boards to a steel profile by means of so-called Conlit® glue, which is a non-combustible adhesive based on water-glass and kaolin.

In stead of gluing the fire protection boards 5 and 6 to each other around the steel profile 1, they can be attached by mechanical means, e.g. by pins welded to the steel profile 1 and penetrating through the fire protection boards 5 and 6 (see FIG. 4), and/or by hook-shaped fasteners for interconnecting the fire protection boards 5 and 6 at the corners where they meet. How the fire protection boards 5 and 6 are attached to the steel profile 1 is not important for the present invention.

If the fire protection boards 5 and 6 are made of mineral wool they conventionally have a density of between 120 and 150 kg/m³, which means that they are relatively rigid mineral wool products that have sufficient rigidity and strength to maintain a closed (or semi-closed) structure around the steel profile 1 even if they are exposed to high temperatures or small impacts.

In order to improve the resistance against point impact, two hard plates, preferably gypsum plates 8 and 9, are attached to the outer surfaces of the fire protection boards 5 and 6 by means of an adhesive 10 which preferably is a non-combustable adhesive based on cement, e.g. so-called Conlit® Cement glue. The two hard plates might be conventional gypsum plates, i.e. gypsum plates provided with a paper fleece on both sides.

Preferably the adhesive 10 is applied on the full outer surfaces of the fire protection boards 5 and 6, so that the gypsum plates 8 and 9 are fully adhered to the fire protection boards 5 and 6. This is particularly relevant for the gypsum plate 9 which covers the fire protection board 6 that spans freely between the two flanges 3 and 4 of the steel profile 1, since a full adherance contribute substantially to the rigidity and strength of the combined structure. As an example, it is found that a 25 mm thick Conlit® mineral fibre board was mounted onto a structure and covered with gypsum plates having a thickness of 13 mm would provide the same fire protection as a 40 mm thick stone wool panel and would satisfy the requirements specified in European standard ENV 13381-4.

In excess of providing a hard surface and a substantially improved resistance against point impact the gypsum plate 8 also covers the interface between the two fire protection boards 5 and 6. Thereby the inherently weakest point in the fire protection is covered and the risk of fail during a fire is further reduced.

The corner connection between the hard gypsum plates 8 and 9 may be covered by a corner profile 11 as shown in FIG. 2, or the edges of the gypsum plates 8 and 9 can be interconnected by a connecting profile 12 with notches that receives the edges of the gypsum plates 8 and 9 as shown in FIG. 3.

If the corner is provided with a corner profile 11 as shown in FIG. 2 it is preferred to level out the surfaces by a thin layer of plaster and then subsequently apply a glass fleece and paint.

If the corner is provided with a connecting profile 12, e.g. an aluminium profile, as shown in FIG. 3, it might be desired only to treat the surface of the plates 8 and 9 and leave the connecting profile 12 exposed as corner decoration and protection.

In case the hard plates 8 and 9 have finished edges a separate corner element can be omitted and the structure can be as shown in FIG. 1.

FIG. 4 shows another example of a system according to the invention. In this case the structural element is a ventilation duct 13. The fire protection boards 5 and 6 made of mineral wool are attached to the ventilation duct 13 by pins 14 extending through the fire protection boards 5 and 6 and welded to the surface of the ventilation duct 13. At the outer end each pin 14 is provided with a disc 15 that retains the fire protection boards 5 and 6.

After the fire protection boards 5 and 6 have been mounted on the ventilation duct 13 a layer of adhesive 10 is applied to the outer surfaces of the fire protection boards 5 and 6. Then the hard plates, such as gypsum plates 8 and 9, are put onto the glued surfaces of the fire protection boards 5 and 6 and thereby attached fully thereto. Finally, a corner profile 11 is attached to the edges of the gypsum plates 8 and 9. The final finish might then be achieved by applying a thin layer of plaster, a glass fleece and typically also a finishing paint.

The invention has been described with reference to some perferred embodiments, but it is not restricted to these specific embodiments. The invention is particularly advantageous in relation to fire protection of free standing steel beams or columns and ventilation ducts, since this requires a lot of cutting and adjustment of both the fire protection boards and the hard plates. However, by the invention it is realised that other structural elements may be protected by a system according to the invention other than steel structures. Other types of structures may include structures made of wood, aluminium, concrete, etc.

1. A system for fire protection of a structural element, said system comprising:
one or more fire protection boards; and
at least one hard plate which is attached to an outer surface of each of the one or more fire protection boards by a non-combustable adhesive, said hard plates having a harder surface than the fire protection board.

2. A system according to claim 1, wherein the fire protection boards comprise mineral wool bonded by a binder.

3. A system according to claim 1, wherein the fire protection boards have a density of between 50 or 60 and 250 kg/m³.

4. A system according to claim 1, wherein the hard plates are gypsum plates, which are optionally provided with a paper fleece on one or both sides.

5. A system according to claim 1, wherein the adhesive is based on cement.

6. A system according to claim 1, wherein said one or more fire protection boards are attached to a structural element which is a part of a steel structure for a building.

7. A system according to claim 6, wherein the structural element is a load bearing structure for a building.

8. A system according to claim 1, wherein said one or more fire protection boards are attached to a structural element which is a ventilation duct.

9. A system according to claim 1, wherein said one or more fire protection boards are attached to a structural element which comprises a planar surface.

10. A method for fire protecting a structural element comprising the following steps:
attaching one or more fire protection boards to the structural element,
applying a non-combustible and uncured adhesive to at least one outer surface of the fire protection boards,
attaching one or more hard plates to the uncured adhesive, said hard plates having a harder surface than the fire protection board,
curing the adhesive such that the hard plates becomes glued to the fire protection boards.

11. A method according to claim 10, wherein the fire protection boards are attached to the structural element by applying an adhesive to interfaces between abutting surfaces and/or edges of the fire protection boards.

12. A method according to claim 10, wherein the fire protection boards are attached to the structural element by using mechanical fasteners.

13. A method according to claim 10, wherein the fire protection boards comprise mineral wool bonded by a binder.

14. A method according to claim 13, wherein the fire protection boards have a density of between 50 and 250 kg/m³.

15. A method according to claim 10, wherein the hard plates are gypsum plates, optionally provided with a paper fleece on one or both sides.

16. A method according to claim 10, wherein the adhesive is based on cement.

17. A method according to claim 10, wherein at least two hard plates are arranged to meet at a corner whereafter one or more corner reinforcement profiles are attached to the abutment of the two outer surfaces of the two adjoining hard plates.
